(19) United States
(12) Patent Application Publication
(10) Pub. No.: US 2004/0199371 A1
(43) Pub. Date: Oct. 7, 2004

(54) Method of configuring simulation program for computing amounts of heat exchanged and storage medium containing the simulation program

(75) Inventors: Masae Sasano, Kanagawa (JP); Nobuhiro Kusumoto, Kanagawa (JP); Takefumi Inagaki, Kanagawa (JP)

Correspondence Address: McDERMOTT, WILL & EMERY, 600 13th Street, N. W., Washington, DC, 20005-3096, US

(73) Assignee: FUJITSU GENERAL LIMITED

(21) Appl. No.: 10/815,686

(22) Filed: Apr. 2, 2004

(30) Foreign Application Priority Data
Apr. 3, 2003 (JP) 2003-100700

(51) Int. Cl. G06F 9/45

(52) U.S. Cl. 703/22

(57) ABSTRACT

The present invention provides a simulation method for an apparatus which produces refrigeration effect by means of heat exchange between refrigerant and air, wherein the simulation method provides good expandability to allow new parts to be added and so on. The method includes the steps of: classifying models which represent phenomena occurring in various components of an apparatus for producing refrigeration effect by means of heat exchange between refrigerant and air into categories independent of one another; defining the resulting categories as classes; defining an abstract class by extracting characteristics common to a plurality of similar parts contained in each category if these parts need to be distinguished for the purpose of calculation; providing, under the abstract class, as many subclasses which inherit character of the abstract class as there are necessary types of part; implementing a phenomenological model of each defined class; and creating a simulation program in an object-oriented language based on the classes.

### BACKGROUND OF THE INVENTION

1. Field of the Invention

The present invention relates to a simulation program which simulates amounts of heat exchanged in an apparatus for producing refrigeration effect by means of heat exchange between refrigerant and air as well as to a class definition method for use in writing the program in an object-oriented language.

2. Description of the Related Art

Apparatus which produce refrigeration effect by means of heat exchange between refrigerant and air include, for example, a refrigeration system or a heat exchanger which functions as part of the refrigeration system. In designing such an apparatus, it has been a practice to predict amounts of heat exchanged in the apparatus, using a simulation program. If the amounts of heat exchanged in such an apparatus can be predicted with high accuracy, it will be possible to predict performance of the designed apparatus as well as to design the apparatus according to required performance. A method for simulating a refrigerant circuit is proposed, for example, by Patent Document 1 while a method for simulating a heat exchanger is proposed, for example, by Patent Document 2.

1. Japanese Patent Laid-Open No. 09-257319

2. Japanese Patent Laid-Open No. 07-281727

The method for simulating a refrigerant circuit described in Patent Document 1 expresses connections among a compressor, evaporator, condenser, heat exchanger, and the like composing the refrigerant circuit by a matrix and registers parameters of these components in advance based on model names, allowing the user to perform a simulation only by specifying a model name. However, this method does not allow tubes connecting the components to be replaced partially with other parts. Also, although the method allows specifications for the heat exchanger and the like to be changed, this consists only in allowing parameter values to be changed, and not in allowing new parameters to be adopted. To adopt a new parameter, there is no way but to write a definition of a new function into a main program.

The method for simulating a heat exchanger described in Patent Document 2 divides the heat exchanger into multiple parts, determines the amounts of heat transferred by the individual parts, and sums the amounts to determine the total amount of heat transferred by the heat exchanger. However, the document does not describe any particular method of division or expandability to adopt new parts.

Conventional simulators of refrigeration systems or heat exchangers allow the user to specify only macroscopic parameters such as rough sizes of various parts, including surface areas and widths of the heat exchangers, during program execution, and parameters related to internal structures such as layout of paths along which the refrigerant flows or partial use of tubes with different shapes are embedded in programs in advance. When actually designing a heat exchanger, its internal structure is sometimes modified: for example, fins or tubes may be partially replaced with different ones depending on the situation. Thus, conventional simulators, whose structural details are defined in the program, are inconvenient to use as design support tools.

Conventional simulation programs of refrigeration systems or heat exchangers treat heat exchange between air and refrigerant as a single process and perform all calculations for it using the same function. Generally, equations which represent physical phenomena such as heat transfer and friction vary with the geometric characteristics of fins, tubes, etc. of the heat exchanger (e.g., whether tubes are grooved or what type of fins are used), so a simulation program must be created anew for each combination of different shapes. This method requires the entire core program to be modified, for example, by the addition of flags or functions, each time a new model of tubes or fins with a new shape is introduced. Consequently, it cannot flexibly accommodate changes of components of the heat exchanger to be simulated or introduction of new models which represent heat transfer coefficients.

Besides, the conventional simulation programs of refrigeration systems or heat exchangers employ an argument to list all variables used in a function for calculation of a physical quantity. With this method, a function interface to each model of a part must be known beforehand in the coding phase and function interfaces for all models likely to be used must be described in the main program. Thus, it provides poor expandability when it becomes necessary to add new parts. This is also true when updating an argument list after an existing computational model is updated. Furthermore, although the conventional programs employ conditional branching algorithms which use a flag to select an appropriate equation, algorithms which use flags make the program complex because actual heat exchangers do not necessarily use tubes of the same type from inlet to outlet of the refrigerant, but use a combination of straight tubes, joints, bends, branches, junction tubes, etc.

The present invention has been made in view of the above problems and has an object to provide a simulation method for an apparatus which produces refrigeration effect by means of heat exchange between refrigerant and air, wherein the simulation method makes it easy to modify internal structure—for example, to replace part of fins or tubes with different ones depending on the situation—as when actually designing a heat exchanger and provides good expandability to allow new parts to be added.

### SUMMARY OF THE INVENTION

The present invention provides a method of configuring a simulation program for computing amounts of heat exchanged, comprising the steps of: classifying models which represent phenomena occurring in various components of an apparatus for producing refrigeration effect by means of heat exchange between refrigerant and air into categories independent of one another; defining the resulting categories as classes; defining an abstract class by extracting characteristics common to a plurality of similar parts contained in each category if these parts need to be distinguished for the purpose of calculation; providing, under the abstract class, as many subclasses which inherit character of the abstract class as there are necessary types of part; implementing a phenomenological model of each defined class; and creating a simulation program in an object-oriented language based on the classes.

This configuration provides a simulation program for an apparatus which produces refrigeration effect by means of heat exchange between refrigerant and air, wherein the simulation program makes it easy to modify internal structure—for example, to replace part of fins or tubes with different ones depending on the situation—as when actually designing a heat exchanger and provides good expandability to allow new parts to be added.

### BRIEF DESCRIPTION OF THE DRAWINGS

FIG. 1 is a flowchart showing a flow from definition of classes to creation of phenomenological models according to the present invention;

FIG. 2 is a diagram showing constituent classes of a refrigeration system simulator according to the present invention; and

FIG. 3a and FIG. 3b is a diagram showing constituent classes of a heat exchanger simulator according to the present invention.

### DETAILED DESCRIPTION OF THE PREFERRED EMBODIMENTS

An embodiment of the present invention will be described with reference to the drawings.

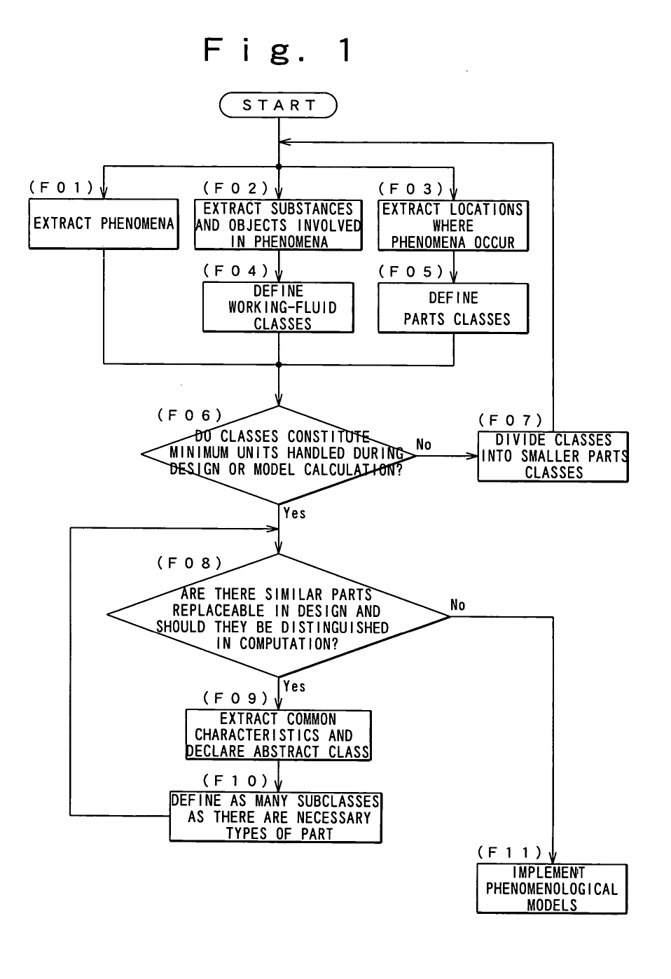

A simulation method for an apparatus which produces refrigeration effect by means of heat exchange between refrigerant and air according to the present invention is performed using a simulation program, whose code is written in an object-oriented language by expressing parts classes and working-fluid classes in such a way that the simulator will be composed of independent component objects. Methods for defining classes include a flowchart shown in FIG. 1 and this definition method is one of the features of the present invention.

Now, the flowchart in FIG. 1 will be described. To create a program for simulating an apparatus which produces refrigeration effect by means of heat exchange between refrigerant and air, phenomena which occurs on the apparatus are observed and extracted (F01). At the same time, substances and objects involved in the phenomena are extracted (F02) and the locations in which the phenomena occur are extracted (F03). The extracted substances and objects are classified into working-fluid classes (F04) and the locations in which the phenomena occur are classified into parts classes (F05). It is necessary to check whether the classes defined above constitute minimum units handled during design or model computation (F06). The term “minimum units” here is used in the sense that the models which represent phenomena occurring in various components are independent of one another and do not affect one another. The minimum units are obtained by dividing the program until rewriting a part of program code no longer affect other parts of the program. If the defined classes are not minimum units, the flow returns to the start to subdivide them into smaller parts classes (F07). On the other hand, if the defined classes are minimum units, the flow goes to F08.

Regarding each parts class judged to constitute a minimum unit, it is determined whether a plurality of similar parts replaceable in design are available and whether they should be distinguished in computation (F08). If it is determined that there is no similar part replaceable in design or that a plurality of similar parts replaceable in design are available but do not need to be distinguished in computation, the flow goes to F11. If it is determined that a plurality of similar parts replaceable in design are available and should be distinguished in computation, an abstract class is declared by extracting characteristics common to the a plurality of similar parts (F09). As many subclasses as there are necessary types of part are defined under the abstract class (F10). Again, it is determined whether each subclass has a plurality of similar parts replaceable in design and whether they should be distinguished in computation (F08). Then, a loop “F09->F10->F08” is repeated as appropriate. Otherwise, the flow goes to F11. Once the classes are established, implementation functions for the models of phenomena which can actually occur are written according to parts materials and working fluids relevant to the classes (F11).

By defining working-fluid classes and parts classes based on the flowchart in FIG. 1 and creating a simulation program based on the class definition in an object-oriented language, it is possible to configure a simulator with good expandability. As a more concrete example, description will be given of a case in which a simulation program of a refrigeration system is created based on the flowchart.

First example:

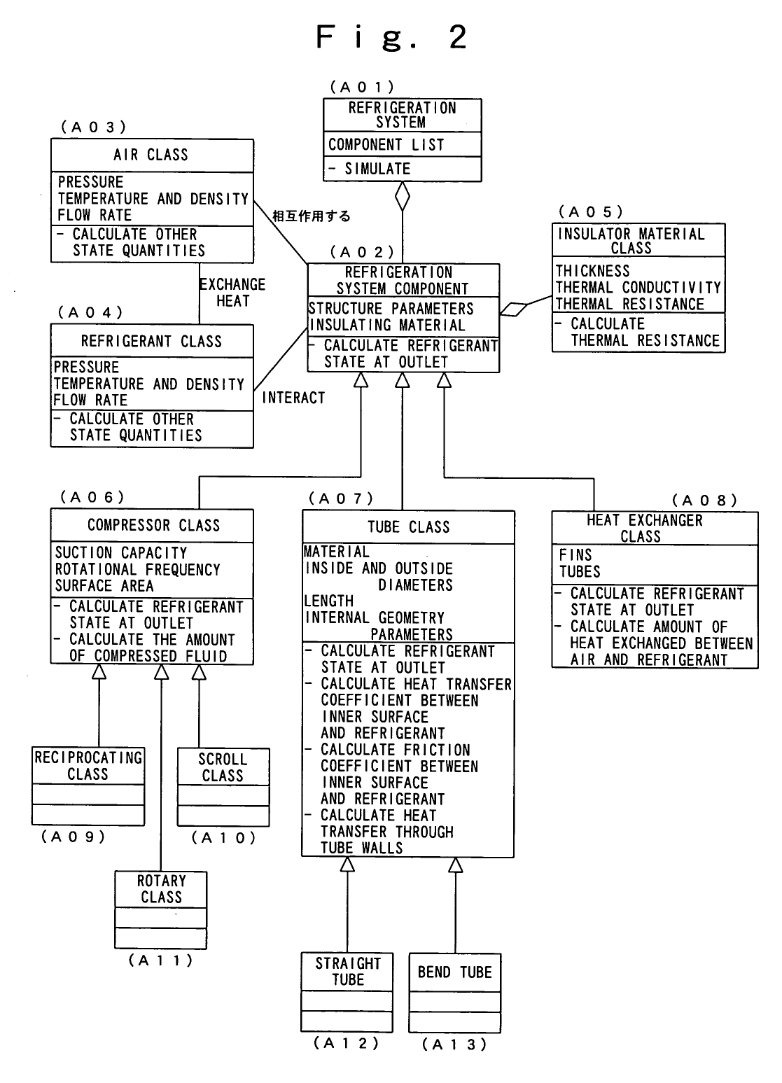

A refrigeration system consists of compressors, tubes, heat exchangers, insulating material, etc. and produces refrigeration effect. Referring to FIG. 2, description will be given of an example in which the simulation method according to the present invention is used to create a program for simulating the amount of heat exchanged between refrigerant and air in these components as a whole. The refrigeration system (A01) is composed by summing up a refrigeration system component class (A02). As working-fluid classes which interact with the refrigeration system component class (A02), an air class (A03) and refrigerant class (A04) are defined. By taking into consideration a situation in which components are covered by insulating material, the refrigeration system component class (A02) includes an insulator material class (A05). These classes are defined in F01 to F05 of the flowchart in FIG. 1.

When it is determined whether the refrigeration system component class (A02) constitutes a minimum unit handled during design or during model calculation (F06), refrigeration system components include compressors, tubes, heat exchangers. If it is determined that treating them as a single group will reduce simulation accuracy, a compressor class (A06), tube class (A07), and heat exchanger class (A08) are defined as inheritance classes of the refrigeration system component class (A02).

In relation to the three classes—compressor class (A06), tube class (A07), and heat exchanger class (A08)—described above, it is necessary to determine, in the flowchart (F08) in FIG. 1, whether each class contains similar parts replaceable in design and, if containing, whether they should be distinguished in computation. For example, if a simulation is performed by simply defining the compressor class (A06), differences among types of compressor are not reflected in the simulation. To reflect the differences among types of compressor, the compressor class (A06) can be declared as an abstract class in the flowchart (F09) in FIG. 1 and a subclass which inherits the character of the compressor class (A06) can be defined for each type of compressor in F10. Possible types of compressor include, reciprocating, scroll, rotary, and other types and if a reciprocating class (A09), scroll class (A10), and rotary class (A11) are defined, it is possible to perform simulations by selecting a compressor type. Similarly, if a simulation is performed by simply defining the tube class (A07), differences among types of tube are not reflected in the simulation. To reflect the differences among types of tube, the tube class (A07) can be declared as an abstract class in the flowchart (F09) in FIG. 1 and a subclass which inherits the character of the tube class (A07) can be defined for each type of tube in F10. Possible types of tube include, straight, bend, and other tubes. If a straight tube class (A12) and bend tube class (A13) are defined, it is possible to perform simulations by selecting an optimum class in each segment even if different types of tube must be used in different segments. This improves the accuracy of the simulation.

For each of the classes thus defined, models of phenomena which can occur in the class are implemented (F11). For example, a function for calculating refrigerant state at an outlet and a function for calculating the amount of heat release of a compressed fluid are implemented for the compressor class (A06). Functions are implemented for other classes as well based on the phenomena which can occur in the respective classes.

By considering a refrigeration system as a collection of components, defining a class for each component, simulating the amount of heat exchanged in the component, and then summing the amounts of heat exchanged in the individual components, it is possible to simulate the amount of heat exchanged in the entire refrigeration system. Also, according to the present invention, the simulation program, which is written in an object-oriented language, makes it easy to newly define parts classes under a class by inheriting the character of that class, and thus allows simulations to be performed using finer settings. The simulation program, which allows the accuracy of simulations to be tailored to a user's needs, can be said to have a very high expandability.

In the above example, a method of configuring the simulation program for the entire refrigeration system has been described, but details of the heat exchanger, one of the components, have been left unmentioned. However, the present invention is not limited by this. The program may be configured to make detailed settings for the heat exchanger and simulate accurately the amount of heat exchanged in the heat exchanger. Now, description will be given of how to configure a simulation program for a heat exchanger by defining parts classes based on the flowchart in FIG. 1.

Second example:

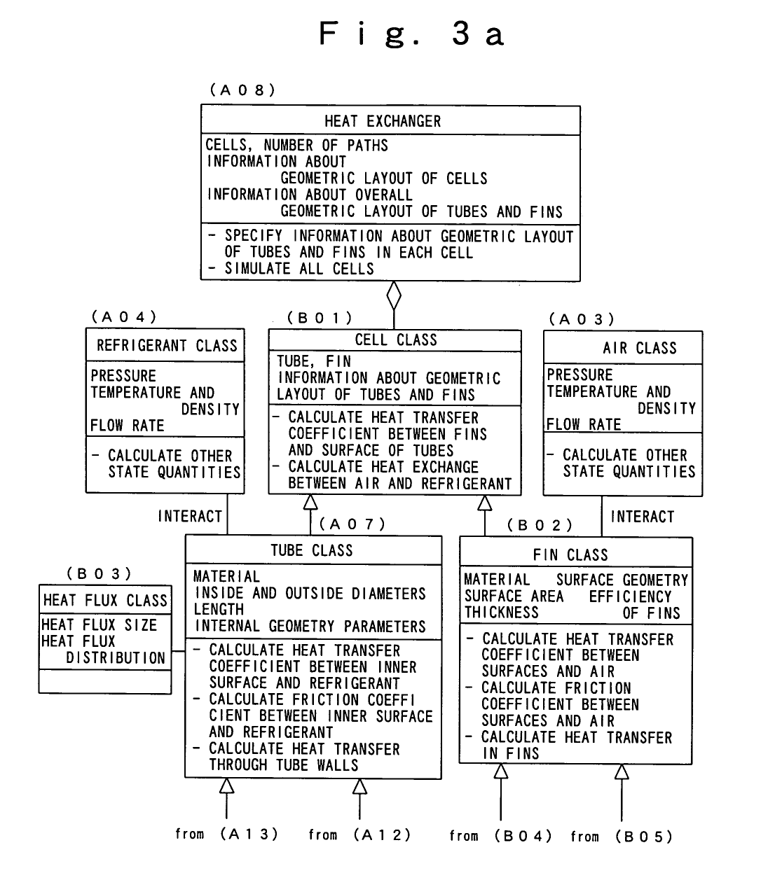

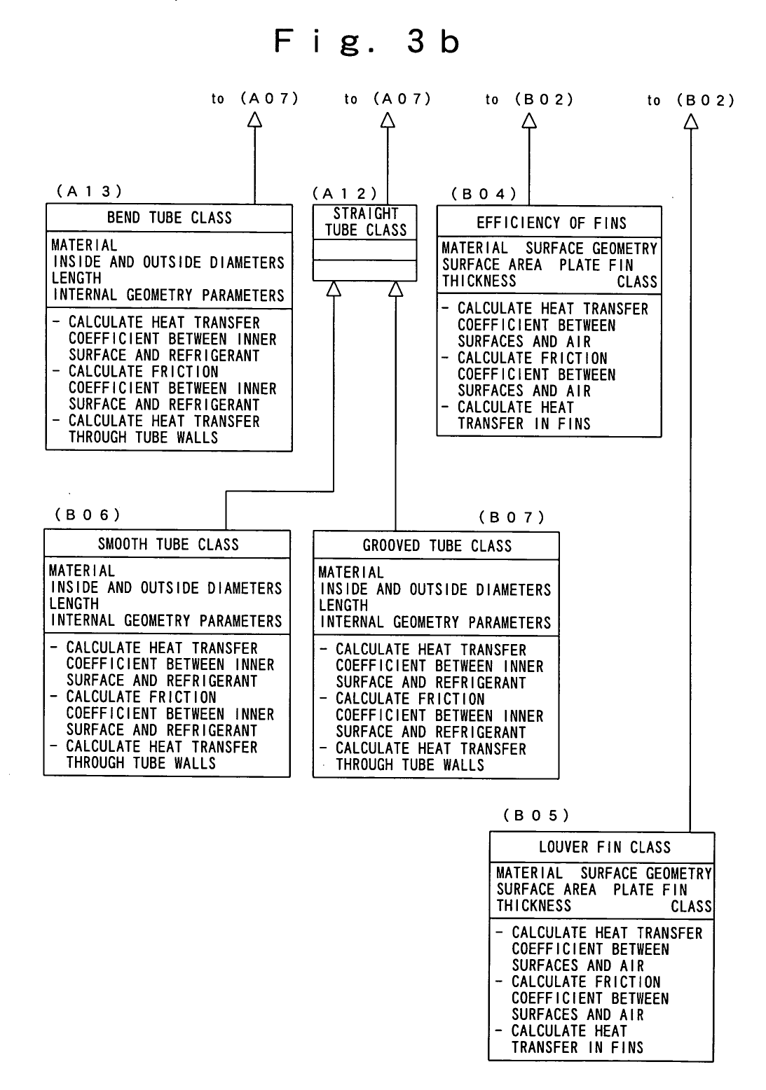

A method of configuring a simulation program for a heat exchanger will be described with reference to FIG. 3a and FIG. 3b. In the first example described above, the amount of heat exchanged has been calculated by dividing the refrigeration system into components. In the case of the heat exchanger, the amount of heat exchanged in the heat exchanger will be found by dividing the heat exchanger into small segments called cells, calculating the amount of heat exchanged in each cell, and then summing the amounts of heat exchanged in all the cells. The size of the cells to be divided are set small enough to represent state changes of working fluids occurring in each cell by a single type of equation without any trouble.

To reflect the method of division into cells in class definition, the heat exchanger (A08) is composed by summing up a cell class (B01) as shown in FIG. 3a. Information about geometric layout of cells, the number of paths, overall geometric layout of tubes and fins, and the like is written for the heat exchanger (A08).

The heat exchanger is composed of a combination of tubes and fins. This is also true even if the heat exchanger is divided into smaller units of cells, and thus the cell class (B01) is composed by combining a tube class (A07) and fin class (B02) as shown in FIG. 3a. In the smaller units of cells, the tubes can be assessed taking into consideration only interaction with the refrigerant ignoring interaction with air and the fins can be assessed taking into consideration only interaction with air ignoring interaction with the refrigerant. Thus, the tube class (A07) takes into consideration the interaction with the refrigerant class (A04) while the fin class (B02) takes into consideration the interaction with the air class (A03).

Also, in the case of the tube class (A07), a heat flux class (B03) is defined and interaction between the tube class (A07) and heat flux class (B03) is considered because influence of heat fluxes are sometimes taken into consideration during calculation of heat transfer coefficients.

Incidentally, the tube class (A07) is denoted by the same reference characters as the tube class in the simulation program for the refrigeration system in FIG. 2. This means that once a tube class is defined in the simulation program of the refrigeration system, the same tube class can be called and used in the simulation program of the heat exchanger. This also applies to other classes which are denoted by the same reference characters in FIGS. 2 and 3.

As is the case with the refrigeration system in FIG. 2, if a simulation is performed by simply defining the tube class (A07), differences among types of tube are not reflected in the simulation. However, if the tube class (A07) is declared as an abstract class and a straight tube class (A12) and bend tube class (A13) are defined as subclasses which inherit the character of the tube class (A07), it is possible to perform simulations by selecting an optimum class in each segment even if different types of tube must be used in different segments. Besides, straight tubes include smooth tubes and grooved tubes. If it is necessary to distinguish them in calculation, the difference in the type of straight tube can be reflected in the results of simulation by declaring the straight tube class (Al2) as an abstract class and defining a smooth tube class (B06) and grooved tube class (B07) are defined as subclasses which inherit the character of the straight tube class (A12).

Also, if a simulation is performed by simply defining the fin class (B02), differences among types of fin are not reflected in the simulation. However, if the fin class (B02) is declared as an abstract class and defining a plate fin class (B04) and louver fin class (B05) are defined as subclasses which inherit the character of the fin class (B02), it is possible to perform simulations by selecting an optimum class in each segment even if different types of fin must be used in different segments.

For each of the classes thus defined, models of phenomena which can occur in the class are implemented (F11). For example, a function for calculating a heat transfer coefficient between surfaces and air, a function for calculating a friction coefficient between surfaces and air, and function for calculating heat transfer in the fins are implemented for the plate fin class (B04). Functions are implemented for other classes as well based on the phenomena which can occur in the respective classes.

In this way, by considering the heat exchanger as a collection of small cells into which it is divided and considering each cell as a combination of tubes and fins, calculating the amount of heat exchanged in the tubes in each cell with interaction of air with the refrigerant taken into consideration and calculating the amount of heat exchanged in the fins with interaction with air taken into consideration, and summing the amounts of heat exchanged in all the cells, it is possible to simulate the amount of heat exchanged in the entire heat exchanger. Also, according to the present invention, the simulation program, which is written in an object-oriented language, makes it easy to newly define parts classes under a class by inheriting the character of that class, and thus allows simulations to be performed using finer settings. Thus, the simulation program, which allows the accuracy of simulations, computing equations, or the like to be tailored freely to a user's needs, can be said to have a very high expandability.

To take a concrete example, when the refrigerant flows in a smooth tube, a friction coefficient formula is given by:

$$\frac{1}{\sqrt{f}} = 2.01 log ( Re \sqrt{f} ) - 0.8 \qquad ( 1 )$$

where Re is a Reynolds number.

When the refrigerant flows in a tube having spiral grooves, a friction coefficient formula is given by:

$$f = 0.04 \cdot {Re}^{- 0.20} \frac{{D}_{n}}{{D}_{h}} \sqrt{\frac{{A}_{fa}}{{A}_{fn}} {( sec β )}^{0.75}} \qquad ( 2 )$$

where Dn, Dh, Afa, Afn, b are tube structure parameters.

Thus, it can be seen that the friction coefficient formula varies with the type of tube. Conventional methods of configuring a program must give different names to functions in the main program. However, with a program written in an object-oriented language as is the case with the present invention, if a friction coefficient formula is defined for each class using the same function name f, by simply giving an instruction “calculate f” in the main program, it is possible to calculate the function f for the class selected within each cell. This makes it possible to accommodate changes of formula flexibly.

Another friction coefficient formula may be used for the same tube having spiral grooves as shown below:

$$f = 8.633 \cdot e \cdot {{p}^{- 0.5} ( \frac{Re}{5000} )}^{- 0.2} \qquad ( 3 )$$

where Re is a Reynolds number and e and p are tube structure parameters.

Even in this case, since the program is written in an object-oriented language, the situation can be dealt with by simply defining a new class to calculate Equation (3). In this way, by using the concept of class, it is possible to make changes without rewriting the main program, and thus ensure very high expandability of the program.

Incidentally, the sources of Equations (1) to (3) are as follows:

(1) Equation of Smooth Tubes

Prandtl-Karman formula, edited by the Japan Society of Mechanical Engineers, Handbook of Mechanical Engineering A5, p.75

(2) Carnavos' Equation of Tubes Having Spiral Grooves

Carnavos, T. C., Heat transfer performance of internally finned tubes in turbulent flow, Heat Transfer Engineering, 1(4), pp.32-37, 1980

(3) Equation of JSME Standard for Tubes Having Spiral Grooves

JSME S011, Method for Thermal Design of Heat Exchanger, p.35, 1996

In the second example described above, the simulation program for the heat exchanger simulates the amount of heat exchanged in the entire heat exchanger by considering the heat exchanger as a collection of small cells into which it is divided and considering each cell as a combination of tubes and fins, calculating the amount of heat exchanged in each cell with interaction with the working fluid taken into consideration, and summing the amounts of heat exchanged in all the cells. The present invention, which performs simulations by considering each cell as a combination of tubes and fins, makes it possible to calculate the amount of heat exchanged in the tubes with only relationship between refrigerant and heat fluxes taken into consideration and calculate the amount of heat exchanged in the fins with only relationship with air taken into consideration. This makes it possible to create highly reusable programs. Also, by defining child classes which inherit the character of their parent class both in the case of tubes and fins, it is possible to specify smaller differences of parts without rewriting the main program.

According to the second example described above, the simulation program, which is configured to allow setting of fin and tube characteristics on a cell-by-cell basis, can reproduce the configuration of an actual device faithfully, and thus provide a very convenient design tool.

Also, by expressing a heat exchanger model by the combination of actual part concepts such as fins and tubes and describing phenomena such as heat transfer and friction as being closed within the fields (parts) in which they occur, it is possible to configure the program in such a way that the air side and refrigerant side will not affect each other even if the method of representing heat transfer phenomena differs between the air and refrigerant sides.

By classifying fins and tubes into abstract parts classes, defining louver fin, plate fin, smooth tube, grooved tube, and other classes as derivatives of the abstract parts classes, and defining parameter sets needed for simulations as refrigerant state, air state, heat flux state, and other classes in the derivative classes, it is possible to share function interfaces used to calculate air-side thermal conductivity and refrigerant-side thermal conductivity within the heat exchanger model. If function interfaces are shared, required functions can be called using the same code description even if tubes under the heat exchanger class differ in internal geometry. This eliminates the need to prepare flags unlike conventional methods. When introducing a new type of part, all that is necessary is to define a new parts class and expand the class used for arguments, and simulation functions of the heat exchanger are not affected.

A method set forth in claim 1 of the present invention, comprises the steps of: classifying models which represent phenomena occurring in various components of an apparatus for producing refrigeration effect by means of heat exchange between refrigerant and air into categories independent of one another; defining the resulting categories as classes; defining an abstract class by extracting characteristics common to a plurality of similar parts contained in each category if these parts need to be distinguished for the purpose of calculation; providing, under the abstract class, as many subclasses which inherit character of the abstract class as there are necessary types of part; implementing a phenomenological model of each defined class; and creating a simulation program in an object-oriented language based on the classes. This configuration provides a simulation program for an apparatus which produces refrigeration effect by means of heat exchange between refrigerant and air, wherein the simulation program makes it easy to modify internal structure—for example, to replace parts partially with different ones depending on the situation—as when actually designing an apparatus and provides good expandability to allow new parts to be added.

A method set forth in claim 2 of the present invention comprises the steps of: defining a compressor class, tube class, and heat exchanger class among which models that represent phenomena occurring in a refrigeration system for producing refrigeration effect by means of heat exchange between refrigerant and air are independent of one another; defining an abstract class by extracting characteristics common to a plurality of similar parts contained in each class if such parts exist; providing, under the abstract class, as many subclasses which inherit character of the abstract class as there are necessary types of part; implementing a phenomenological model of each defined class; and creating a simulation program in an object-oriented language based on the classes. This configuration provides a simulation program for a refrigeration system which produces refrigeration effect by means of heat exchange between refrigerant and air, wherein the simulation program makes it easy to modify internal structure—for example, to replace tubes or other parts partially with different ones depending on the situation—as when actually designing a refrigeration system and provides good expandability to allow new parts to be added.

A method set forth in claim 3 of the present invention comprises the steps of: composing the heat exchanger class by combining individual cells in a cell class; combining a tube class and fin class into the cell class as categories among which models that represent phenomena occurring in the cells are independent of one another; defining a refrigerant class for a working fluid which interacts with the tube class; defining an air class for a working fluid which interacts with the fin class; defining an abstract class by extracting characteristics common to a plurality of similar parts contained in each of the tube class and fin class; defining, under each abstract class, as many subclasses which inherit character of the abstract class as there are necessary types of part; implementing a phenomenological model of each defined class; and creating a simulation program in an object-oriented language based on the classes. This configuration provides a heat exchanger simulation program which makes it easy to modify internal structure of a heat exchanger, a part of a refrigeration system—for example, to replace part of fins or tubes with different ones depending on the situation—as is the case when actually designing a heat exchanger and provides good expandability to allow new parts to be added. This improves the accuracy of simulations of the refrigeration system as a result.

A method set forth in claim 4 of the present invention comprises the steps of: composing a heat exchanger which produces refrigeration effect by means of heat exchange between refrigerant and air, by combining individual cells in a cell class; combining a tube class and fin class into the cell class as categories among which models that represent phenomena occurring in the cells are independent of one another; defining a refrigerant class for a working fluid which interacts with the tube class; defining an air class for a working fluid which interacts with the fin class; defining an abstract class by extracting characteristics common to a plurality of similar parts contained in each of the tube class and fin class; defining, under each abstract class, as many subclasses which inherit character of the abstract class as there are necessary types of part; implementing a phenomenological model of each defined class; and creating a simulation program in an object-oriented language based on the classes. This configuration provides a heat exchanger simulation program which makes it easy to modify internal structure—for example, to replace part of fins or tubes with different ones depending on the situation—as when actually designing a heat exchanger and provides good expandability to allow new parts to be added.

Claim 5 of the present invention sets forth a storage medium containing a simulation program which makes a computer implement the functions described in any of claims 1 to 4. This makes it possible to use the simulation program as a design support tool when developing a refrigeration system, heat exchanger, or the like.

What is claimed is:

1. A method of configuring a simulation program for computing amounts of heat exchanged, comprising the steps of: classifying models which represent phenomena occurring in various components of an apparatus for producing refrigeration effect by means of heat exchange between refrigerant and air into categories independent of one another; defining the resulting categories as classes; defining an abstract class by extracting characteristics common to a plurality of similar parts contained in each category if these parts need to be distinguished for the purpose of calculation; providing, under the abstract class, as many subclasses which inherit character of the abstract class as there are necessary types of part; implementing a phenomenological model of each defined class; and creating a simulation program in an object-oriented language based on the classes.

2. A method of configuring a simulation program for computing amounts of heat exchanged, comprising the steps of: defining a compressor class, tube class, and heat exchanger class as categories among which models that represent phenomena occurring in a refrigeration system for producing refrigeration effect by means of heat exchange between refrigerant and air are independent of one another; defining an abstract class by extracting characteristics common to a plurality of similar parts contained in each class if such parts exist; providing, under the abstract class, as many subclasses which inherit character of the abstract class as there are necessary types of part; implementing a phenomenological model of each defined class; and creating a simulation program in an object-oriented language based on the classes.

3. A method of configuring a simulation program for computing amounts of heat exchanged according to claim 2, comprising the steps of: composing the heat exchanger class by combining individual cells in a cell class; combining a tube class and fin class into the cell class as categories among which models that represent phenomena occurring in the cells are independent of one another; defining a refrigerant class for a working fluid which interacts with the tube class; defining an air class for a working fluid which interacts with the fin class; defining an abstract class by extracting characteristics common to a plurality of similar parts contained in each of the tube class and fin class if such parts exists; defining, under each abstract class, as many subclasses which inherit character of the abstract class as there are necessary types of part; implementing a phenomenological model of each defined class; and creating a simulation program in an object-oriented language based on the classes.

4. A method of configuring a simulation program for computing amounts of heat exchanged, comprising the steps of: composing a heat exchanger which produces refrigeration effect by means of heat exchange between refrigerant and air, by combining individual cells in a cell class; combining a tube class and fin class into the cell class as categories among which models that represent phenomena occurring in the cells are independent of one another; defining a refrigerant class for a working fluid which interacts with the tube class; defining an air class for a working fluid which interacts with the fin class; defining an abstract class by extracting characteristics common to a plurality of similar parts contained in each of the tube class and fin class if such parts exists; defining, under each abstract class, as many subclasses which inherit character of the abstract class as there are necessary types of part; implementing a phenomenological model of each defined class; and creating a simulation program in an object-oriented language based on the classes.

5. A storage medium containing a simulation program which makes a computer implement the functions described in any of claims 1 to 4.
